(19) United States
(12) Patent Application Publication
(10) Pub. No.: US 2008/0300867 A1
(43) Pub. Date: Dec. 4, 2008

(54) SYSTEM AND METHOD OF ANALYZING VOICE VIA VISUAL AND ACOUSTIC DATA

(76) Inventor: Yuling Yan, Stanford, CA (US)

Correspondence Address: Yuling Yan, 14 Pearce Mitchell Place, Stanford, CA, 94305, US

(21) Appl. No.: 11/757,390

(22) Filed: Jun. 3, 2007

(51) Int. Cl. G10L 11/04

(52) U.S. Cl. 704/207; 704/E11.006

(57) ABSTRACT

A method and system for the assessment and diagnosis of voice in normal and diseased states can include determining at least one quantitative measure of vocal fold vibration using a laryngeal image recording of a subject's vocal fold obtained from an endoscopic device or an auditory recording of a subject during a phonatory task, and can include subsequent analysis of a waveform selected from waveform types comprising a) an acoustic recording, and b) a glottal waveform that is extracted from the laryngeal image recording. The method and system can generate a comprehensive, at-a-glance, physician friendly visual pattern and characteristics of vocal fold vibrations and correlate with specific voice conditions for diagnosis and assessment of voice and therapies and treatments of voice disorder.

### CROSS-REFERENCE TO RELATED APPLICATION

This application claims priority to U.S. provisional patent applications Ser. No. 60/803,851 and Ser. No. 60/803,850 filed on Jun. 2, 2006, which is hereby incorporated by reference in its entirety.

### BACKGROUND OF INVENTION

1. Field of Invention

Aspects of the present invention relate to systems and methods for an analysis of voice condition and quantification of specific measures of vocal fold vibrations that define voice condition. In one embodiment, the present invention comprises a system and methods for automatically, or interactively tracing vocal-fold motion from images;, for example, digital high-speed laryngeal images, to generate glottal waveforms including but not limited to the glottal area waveform (GAW) and vocal fold displacements. In another embodiment, the present invention relates to a system and methods for subsequent analysis of a selected waveform from an acoustic recording and an image-derived glottal waveform to characterize vocal fold vibration and detect indications in a patient.

2. Background

Voice disorders are a significant medical problem affecting millions of people around the world. According to the American Speech-Language-Hearing Association, over 7.5 million people in the U.S. have some form of laryngeal disorder including laryngeal cancer, Parkinson's, and voice pathologies related to the aging process. Health care costs associated with the diagnosis and treatment of voice disorders and related deterioration in quality of life are substantial.

A description of voice condition, identification of voice conditions that deviate from normal voice and quantification measures that relate the degree of deviation of voice condition from normal are required for assessment of voice condition, monitoring of voice health and evaluation of treatments and therapies for voice conditions. These components are essential for the detection, diagnosis, treatment and management of voice conditions and voice disorders.

Current diagnoses of voice disorders involve perceptive rating of voice condition by listening and/or observation and rating of still or strobe images of the vocal fold. These methods are subjective or qualitative at best and require specialist training and experience that may vary from clinician to clinician. Further, these approaches do not provide insight on the vibratory properties of the vocal fold, which are changed in most voice disorders. An altered vocal fold vibration may lead to a change in voice quality for example, to what is perceived as breathy, rough, hoarse voice, or the like. These voice conditions may arise from irregularity in vocal fold vibration and result from pathologies that alter the vibratory behavior of the vocal folds. In spite of significant advances in understanding the underlying mechanisms of phonation in subjects having normal and specific voice disorders there exists a lack of a quantitative system and measures that describe voice condition and define deviations from normal.

Laryngeal image-based observations of vocal fold vibrations have advanced knowledge of phonation and are often used for clinical diagnoses of voice disorders. In particular, high-speed digital imaging of the larynx is capable of capturing images of vibrating vocal folds at a rate fast enough to resolve the actual phonatory vibrations of the vocal folds and provide an opportunity for development of new tools for assessment of voice and diagnosis of voice disorders. On the other hand, high-speed laryngeal image recordings are large data sets and a challenge to the image processing and data analysis tasks and there is a lack of analytical tools and software to provide effective and efficient processing, analysis and interpretation of the these data files for clinical applications. This invention directs to a system of, and methods for an analysis and quantitative assessment of voice condition from selected one or both of the laryngeal image and acoustic recordings.

Yet defining and characterizing vocal fold vibrations is essential for the assessment of voice; for example, glottal area waveform (GAW), which is the glottis area as a function of time, is often used for this purpose The effectiveness and robustness of GAW analysis depend on accurate extraction of the glottis from series of laryngeal images. In spite of the clear advantages of the high-speed laryngeal imaging modality, for example, the high-speed videoendoscope (HSV) system commercially available in Kay-Pentax, over conventional laryngeal videostroboscopy (LVS), the development of effective software to manage, process and interpret image data has lagged the advances in hardware. In this invention, new methods and system for automatic or interactive, semi-automatic segmentation of laryngeal images (from high-speed or conventional video-rate image recordings), tracing of vocal fold motion and extraction of glottal waveforms are also presented. Additionally, integrative software for the management, processing of laryngeal image recordings and subsequent analyses of image-derived glottal waveforms and robust extraction of several spatiotemporal measures of the vocal fold vibrations are described.

Acoustic signals, on the other hand, are easily recorded and free from bias although for assessments of specific voice disorders current acoustic analysis methods and readouts are sometimes considered inferior to the perceptual ratings by skilled speech pathologists. These difficulties arise because the voice output measured with acoustic techniques is derived from both the glottal source and the modulations of sound by the supra-glottal vocal tract, yet a characterization of the properties of the glottal source (vocal fold vibrations) is necessary for robust, quantitative analysis of voice conditions. Therefore, the current acoustic analyses can only yield information on the glottal source indirectly through inverse filtering, that is, after subtraction of the vocal-tract filter effect. This operation makes it difficult to characterize aberrant vocal fold vibrations commonly associated with voice pathologies. In addition, different voice pathologies can lead to similar effects on the acoustic output. For example, irregularity in an acoustic signal can result from interfering mucus, vocal fold, paralysis or a mass lesion on the vocal folds although some of these contributions can be excluded from imaging the vocal fold motion.

In spite of these issues, the information-rich data from acoustic signals is very useful. The analysis described herein uses high-speed laryngeal images and the acoustic signal that, is simultaneously recorded with the image. This combined analysis can improve the characterization and our understanding of laryngeal dynamics and vocal function and can provide improvements in the clinical assessment and diagnosis of voice disorders.

Voice quality also varies across different speakers. These variations serve to reveal the speaker's identity, age, gender, and the like. Voice quality variances within the same speaker can result from disease or vocal pathologies, voluntary changes in the voice production, for example when one imitates another person, the emotional content of speech, and the like.

### SUMMARY OF THE INVENTION

Laryngeal image-based analyses of vocal fold vibrations have advanced our knowledge of phonation and are often used for clinical diagnoses of voice disorders. In particular, high-speed digital imaging of the larynx enables capturing of the vibrating vocal folds at a rate fast enough to resolve the actual phonatory vibration of the vocal folds and provides an opportunity for development of new objective, quantitative tools for the assessment of voice and diagnosis of voice disorders. However currently, the field lacks analytical tools and software that can provide an effective and efficient processing, analysis and interpretation of the large amount of image data sets to deliver useful clinical information. This invention is directed to a system of and a method for an analysis and quantification of voice condition to meet the need.

The present invention comprises a method and software analysis and hardware system for monitoring and diagnosing voice condition. In one embodiment, an integrative software/hardware system generates robust and quantitative measurements of the vocal fold vibration from image, acoustic or combined image/acoustic data, including but not limited to recordings acquired from high-speed videoendoscopy (HSV) and laryngeal videostroboscopy (LVS).

The software integrates new methods for laryngeal image processing and analysis of vocal fold vibrations and provides interactive, semi-automatic or automatic tracing and extraction of glottal waveforms including but not limited to glottal area waveform (GAW), glottal width function and vocal-fold displacement and velocity functions from laryngeal images and comprehensive, image and acoustic based analyses.

### BRIEF DESCRIPTION OF THE DRAWINGS

In order to more fully describe embodiments of the present invention, reference is made to the accompanying drawings. These drawings are not to be considered limitations in the scope of the invention, but are merely illustrative. For example, these drawings illustrate a procedure of a method and a system, or selected results of analysis using a specific method, according to an embodiment of the present invention. The number of grounding points may vary depending on an embodiment of the present invention.

FIG. 1 shows a flow chart of the software system illustrating the procedure for the processing and analysis of HSV/LVS and acoustic recordings and examples of the readouts from these analyses, according to an embodiment of the present invention.

FIG. 2 illustrates the basic concept of the Nyquist Plot approach to characterize vocal fold vibrations according to an embodiment of the present invention. FIG. 2A shows an HSV-derived, normalized GAW representing a normal voice, and FIG. 2B shows one glottal cycle of the GAW projected on a complex plane using the analytic signal (complex function) derived from the GAW; the opening phase of the vocal fold corresponds to a phase range of −180°˜0° and the closing phase from 0°˜180°. FIG. 2C shows the phase trace or the Nyquist Plot obtained from 20 consecutive glottic cycles. The deviations of the dots from the circle comprising the scatter and the waveform shape distortion indicate the regularity of the glottal waveform and effects of higher-order harmonics or sub-harmonics respectively. The distance (Δ) measures the incomplete glottal closure.

FIG. 3 shows schematics for the three-step process. FIG. 3A shows an HSV image frame, FIG. 3B shows the initial segmented image from step 1, FIG. 3C shows the seed region obtained from step 2, FIG. 3D shows the segmented image from the final region grow step, and FIG. 3E shows the delineated glottis (outlined on the original image).

FIG. 4 shows a flow chart demonstrating the adaptive segmentation method according to an embodiment of the present invention. The method is realized by adaptively identifying an ROI for each image frame; specifically, difference image (DI) is first generated (frame 2) from the original image sequence (frame 1); a median filtering is then applied to the difference image to remove isolated pixels and to better define the ROI. The filtered DI is finally used to define the ROI on a frame-by-frame basis (frame 4). Eventually gray-level threshold segmentation is performed on the defined ROI (within the rectangle marked in frame 5). These operations are illustrated along with segmentation results for an actual HSV sequence (frames 6 and 7).

FIG. 5 shows montage of images showing segmentation results for a sequence of 12 laryngeal images, from a 2000 frame/sec recording, representing a single vibratory cycle of the vocal fold during a sustained vowel phonation from a subject with normal voice.

FIG. 6 shows the GAW (normalized) calculated from the HSV recording of the normal voice according to an embodiment of the present invention.

FIG. 7 shows the segmentation results from a sequence of laryngeal images (16 frames) that represent two cycles of the vocal fold vibration during a sustained vowel phonation from a patient with muscle tension dysphonia according to an embodiment of the present invention.

FIG. 8 shows the GAW (normalized) calculated from 100 image frames of the HSV recording of the dysphonia voice according to an embodiment of the present invention.

FIG. 9 shows spatially resolved vocal fold vibrations at specific anterior, medial and posterior locations of the vocal folds according to an embodiment of the present invention.

FIG. 10 3D display of the spatiotemporal behavior of the vocal folds in voice diplophonia according to an embodiment of the present invention.

FIG. 11 shows normalized GAW extracted from an FISV recording (100 ms) of a normal voice according to an embodiment of the present invention.

FIG. 12 shows acoustic signal (normalized) simultaneously captured from the same normal subject (as FIG. 11) according to an embodiment of the present invention.

FIG. 13 show the Nyquist Plots for the normal voice. FIG. 13A shows the GAW Nyquist Plot, and FIG. 13B shows the acoustic Nyquist Plot according to an embodiment of the present invention.

FIG. 14 shows the FFT power spectra of (A). GAW, and (B). acoustic signal according to an embodiment of the present invention.

FIG. 15 shows the Nyquist Plots for three other normal voice samples. Top row shows the GAW Nyquist Plots, and the bottom row shows the acoustic Nyquist Plots, according to an embodiment of the present invention.

FIG. 16 shows the normalized GAW (upper) and acoustic data (lower) acquired from the RRP patient according to an embodiment of the present invention.

FIG. 17 shows the Nyquist Plots for the pathological voice (RRP voice). Left shows the GAW Nyquist Plot, and Right shows the acoustic Nyquist Plot according to an embodiment of the present invention.

FIG. 18 shows the normalized GAW acquired from the MTD voice revealing a sudden qualitative change in the vocal fold vibratory pattern according to an embodiment of the present invention.

FIG. 19 shows the GAW Nyquist patterns revealing the transition from normal voice (near circular trace Nyquist pattern) to diplophonia (double-ring trace Nyquist pattern) according to an embodiment of the present invention.

FIG. 20 shows Nyquist Plots obtained from the analysis of consecutive data segments

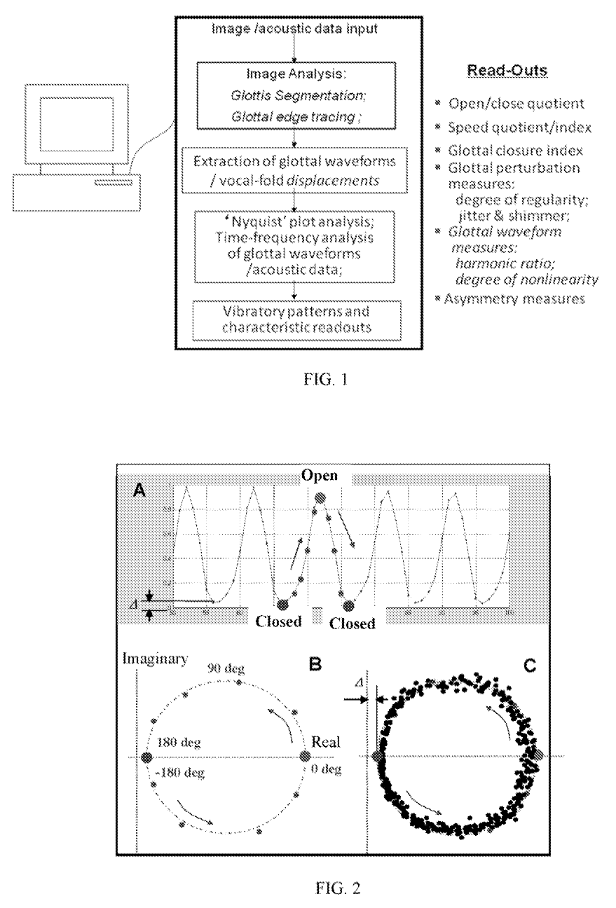

each containing 100-ms recording of GAW (upper) and acoustic data (lower) from the MTD voice according to an embodiment of the present invention.

### DETAILED DESCRIPTION OF THE INVENTION

During sustained vowel phonation, acoustic data, image data alone or in combination with acoustic data, is analyzed by a software and hardware system described in this invention to characterize voice and to detect voice disorders.

In one embodiment, the software/hardware system generates robust and quantitative measurements of the vocal fold vibration from acoustic or acoustic and image data, including but not limited to high speed videoendoscope (HSV) and laryngeal videostroboscopy (LVS) recordings. These quantitative measurements are used for comprehensive analysis of voice conditions, which may be used to detect, monitor and assess voice disorders as well as assist in the development of portable devices for personal health.

The software accepts acoustic data recorded from clinical devices, such as HSV, as well as other forms of digital voice recorders, including but not limited to digital voice recorders (DVRs) and personal digital assistants (PDAs).

In use, the subject phonates a variety of sounds, including but not limited to a short 1 second vowel sound, such as “I”, or a series of short vowel sounds into the recording device. The software accepts multiple file formats and performs a series of operations that are best illustrated in the flow chart (FIG, 1).

The software then integrates several functions for analyzing acoustic or/and image-derived data that include but are not limited to the GAW, glottal width function and vocal fold displacements using several forms of frequency and time-frequency analyses including but not limited to a Nyquist plot analysis. Importantly an acoustic analysis using the Nyquist Plot does not require inverse filtering of the acoustic recordings. The combined imaging and acoustic approach for the analysis of voice condition may lead to a better understanding of the vibratory behavior of the vocal folds and how it correlates with the vocal output and the perceived voice quality. A description of the ‘Nyquist’ plot and Nyquist pattern is provided in the following section.

The inventor has developed a comprehensive, HSV image-based analysis of vocal fold vibratory characteristics of normal and pathological voices using an analytic signal of from the GAW or the acoustic signal and in particular the phase trace of the analytic signal, referred to as ‘Nyquist’ plot. This approach provides a new means to describe instantaneous dynamic behavior of the vocal fold oscillation in terms of a standardized and quantifiable pattern, referred to as Nyquist pattern, which is easily comprehensible and clinician-friendly for use in clinical settings to assist in the assessment of voice and diagnosis and evaluation of treatment of voice disorders. The applications of the Nyquist plot and associated analyses to the GAW or acoustic signal are illustrated in FIG. 2.

In one embodiment of the present invention, the software employs the ‘Nyquist’-plot based approach to generate quantitative analysis of the vocal fold vibration from acoustic or combined acoustic and image recordings. The ‘Nyquist’ plot based approach is employed to generate a comprehensive pattern of the vocal fold vibration and associated quantitative measurements of the vocal fold vibratory characteristics. These measurements may be utilized in correlating properties of the vocal fold vibration and the acoustic signal to perceived voice quality, and in differentiating specific voice pathologies.

The Nyquist plot analysis, as performed by the software, is also desirable for

evaluating the subject's ability to synchronize the vibrations of the vocal fold. This ability may be diagnostic for conditions including, but not limited to, vocal fold paralysis/paresis, Parkinson's disease, vocal fold scarring, laryngeal lesions and cancer, spasmodic dysphonia and hyper-functional dysphonia.
A note on nomenclature and terminology: The context in which the term Nyquist plot is used was referred to as a projection of a complex analytic signal, obtained from a selected waveform from a GAW and an acoustic signal, in a complex plane, or phase plane. In summary the borrowed term of Nyquist plot is different from conventional applications, e.g., in control engineering, rather it expresses similar concept but conveys specific information and operations in the approach described in this invention for an analysis of voice.

As described above, the software may integrate tracing and extraction of glottal waveforms including but not limited to GAW, glottal width function and vocal fold displacements, with the Nyquist plot and other forms of time-frequency analyses of GAW including FFT and short-FFT, or spectrogram, to generate quantitative and robust measures of the vocal fold vibration that correlate with the quality of the voice output.

Vibrations of the vocal folds occur at a high frequency—these vibrations may be imaged, for example, by using HSV, which may capture images, for example, at 2000 frames/sec. Alternatively, the LVS, which records images at only 25 frames/sec and which is more commonly used in the clinic, may also be utilized. The application of HSV and LVS for clinical diagnosis and assessment of voice disorders is achieved through the application of automated software that extracts information on laryngeal vibrations from original laryngeal image recordings, the resolution, contrast and quality of which cannot always be guaranteed.

The various interactive or automatic methods and integrated software for high fidelity, automated extraction of several measures of the vocal fold vibration from HSV recordings and other time series image data are described.

Automatic tracing of glottis and glottal waveform extraction methods and a software for processing image data from HSV, LAS or other time series image data are described.

A first method for interactive and/or automatic image segmentation and extraction/tracing of glottal waveforms including but not limited to GAW, spatially-resolved glottal width function (GWF) and vocal fold displacements may include threshold segmentation employing an interactive grey-level thresholding method to segment the images of the larynx acquired from the HSV (acquisition rate of for example, 2000 frames/sec) or LVS (acquisition rate of, for example, 25-40 frames/sec). In one variation an interactive thresholding segmentation method may be utilized, which is practical for large data sets. The software may allow the user to select a region of interest (ROI), which is not limited to a regular rectangle, and then a threshold value may be interactively adjusted by the user. The software may further allow the user to optimize this process through the use of a ‘slider’ formatting tool together with a real-time display and feedback. Once the ROI has been selected, the thresholding operation may be performed via the software on the ROI within the vocal fold for even frame in the recording on a frame-by-frame basis.

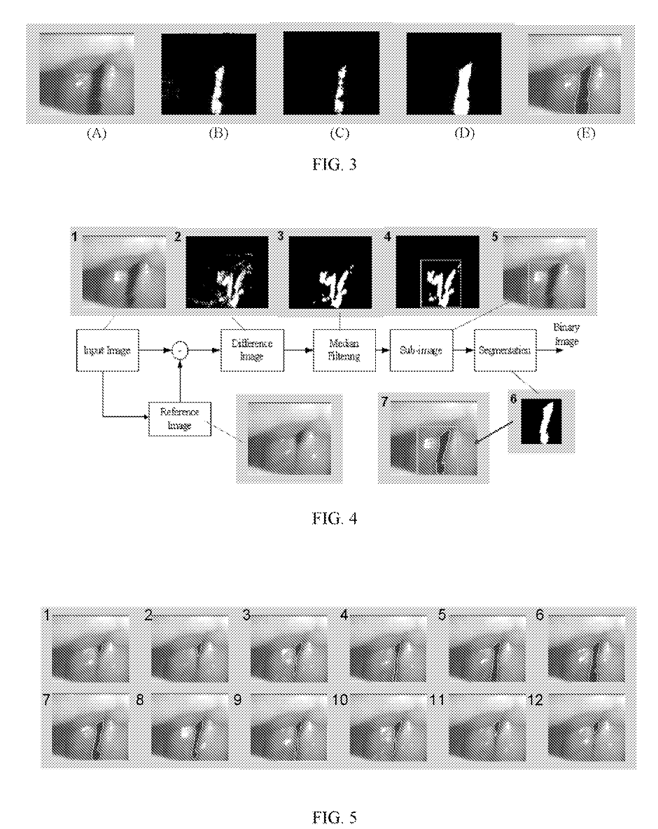

Another method for automatic or semi-automatic segmentation and tracing may use a two-step or three-step process: Obtaining accurate delineation of vocal-fold opening region, or glottis, from sequences of HSV and/or LVS image data sets may involve an interactive two-step process: in the first step, initial segmentation is obtained using thresholding; the threshold value is interactively selected by a user, wherein, one of or both of the gray-level and color attribute can be utilized for the segmentation, in the second step, a final segmentation is obtained using region-growing method; the initially segmented area is used as a ‘seed region’ for the region growing. The software may also involve a three-step, automated process; It may use an unsupervised threshold selection method that is based on histogram modeling, and combined with a region growing operation. Accordingly, in a first step, a histogram-based threshold segmentation (for example by using a Raleigh histogram model) is performed on an HSV/LVS image. In a second step, an erosion operation is subsequently performed to improve the reliability of the initial segmentation. The segmented area is then used as the ‘seed region’ for the third step of the operation. In the third step, a region-growing operation is performed from the seeded region. FIG. 3 schematically illustrates an example of applying the three-step process to a laryngeal image recording obtained from HSV.

Yet another method for automatic, adaptive segmentation that combines grey-level thresholding and motion cues is described in the following section.

In one embodiment the software performs automatic segmentation of laryngeal images from large sequences acquired from HSV as schematized and demonstrated in FIG. 4.

The approach is realized by adaptively identifying an ROI for each image frame; specifically, difference image (DI) is first generated from the original image sequence. A median filtering is then applied to the difference image to remove isolated pixels and to better define the ROI. The filtered DI is then used to define the ROI on a frame-by-frame basis. The DI provides motion cue to identify the ROI, that is, the region where the vocal fold motion occurs, and to remove unwanted static background that may compromise accuracy of the segmentation. A threshold segmentation will finally be performed on the defined ROI and this output is referred to as sub-image. The entire operations are illustrated along with segmentation results for an actual HSV sequence in FIG. 4. The approach fulfils two purposes: (1), it restricts a region of interest for the threshold operation that excludes a significant amount of unwanted data; and (2), it improves the bi modal property of the image for threshold operation.

The three interactive or automated tracing and extraction methods described above may be integrated in a single software program to generate glottal waveforms that include, but are not limited to, the GAW, spatially resolved glottal width function (GWF) and displacement of the vocal fold at free edge. The users can choose one or more of the methods for their applications and comparisons.

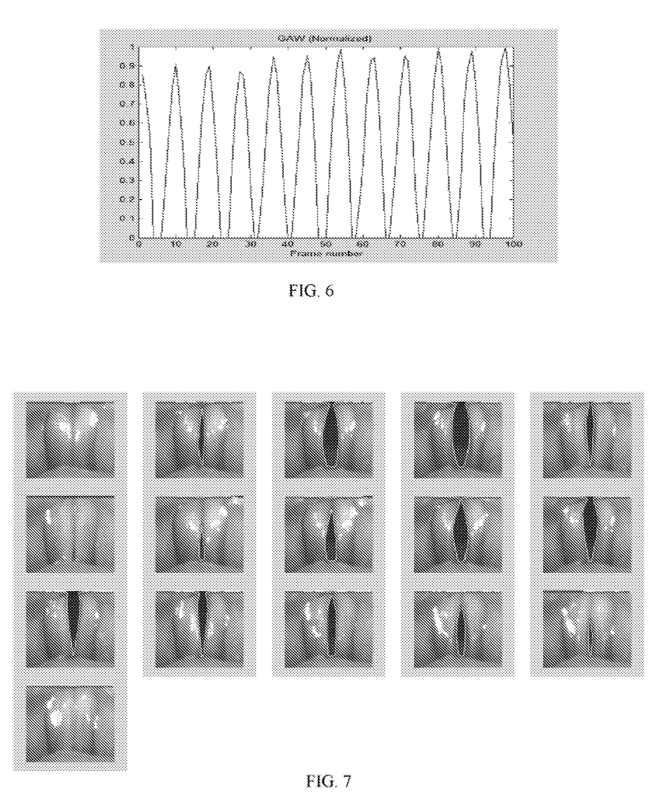

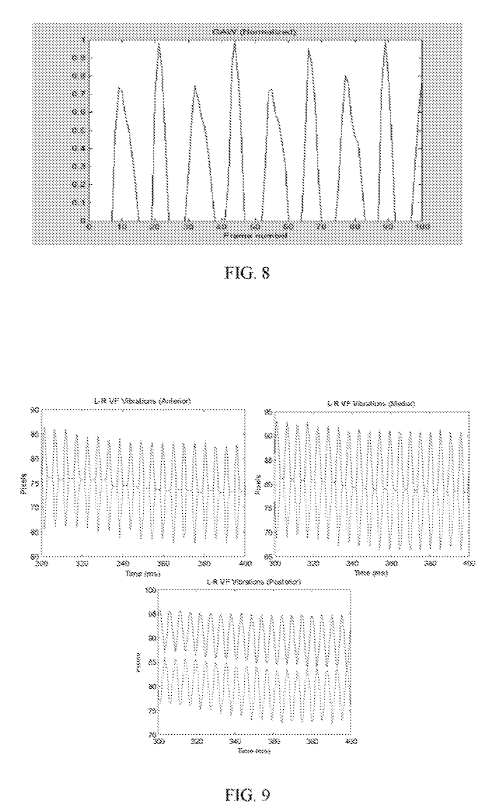

In one variation, such a software program containing these methods is highly effective as evidenced by analyses of clinical HSV recordings from both normal subjects and from those having commonly found pathologies, e.g., using the three-step process. FIG. 5 presents a montage of images showing segmentation results for a sequence of 12 laryngeal images, from a 2000 frame/sec HSV recording, and FIG. 6 shows the extracted GAW from 100 image frames from the same HSV recording, representing 11 vibratory cycles of the vocal fold during a sustained vowel phonation from a subject with normal voice. Results of analyses on an example of pathology voice are shown in FIG. 7 and FIG. 8. In FIG. 7, segmentation results from a sequence of laryngeal images (16 frames) are shown, representing two cycles of the vocal fold vibration during a sustained vowel phonation from a patient with muscle tension dysphonia (MTD). The GAW extracted from 100 image frames of the same HSV recording is shown in FIG. 7.

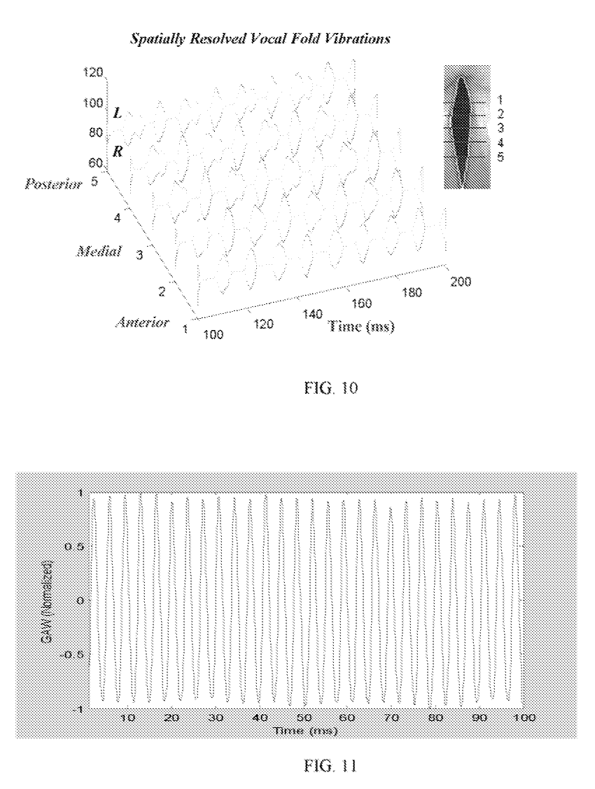

Other variations of the software may include features or functions which enable the user to calculate quantitative measures of the vocal fold vibration for each point along the vocal fold edge, that is, to spatially resolve vibrations for each point along the edge of the vocal folds. FIG. 9 shows an example of the waveforms traced from successful segmentation and delineation of the glottis, which represent the displacements at left (L) and right (R) vocal folds at the specific anterior, medial and posterior locations respectively, obtained from analyses of the HSV recordings of a normal voice. The spatially resolved vocal fold vibrations can also be displayed in three-dimensional (3D); an example is shown in FIG. 10, obtained from analyses of the HSV recordings of the MTD voice.

The high resolution, spatially resolved maps of the vocal fold vibration derived from the software may also be used to provide new measures of vocal fold dynamics and provide information, e.g., on the symmetry and homogeneity of the vocal fold vibration.

Moreover, other variations of the software may include features that enable the user to evaluate specific asymmetries/in-homogeneity/asynchrony in the vocal fold vibrations that associate with specific voice disorders or aging effects. Accordingly, the software provides an approach with robust quantitative metrics that allow the user to correlate specific properties of vocal fold vibrations obtained from e.g., the high-speed laryngeal image recordings with specific voice disorders and which may be utilized with commercially available HSV and conventional LVS instruments

Additional features of the software may include the generation of quantitative, high content, spatially-resolved analyses of the vocal fold vibration as shown in the following section, which may be utilized for analyzing asymmetry and asynchrony in the vibration of the vocal fold and evaluating the subject's control ability to synchronize the local vibrations in the vocal fold tissues that maybe diagnostic for vocal fold paralysis/paresis, Parkinson's disease, vocal fold scarring, laryngeal cancer, spasmodic dysphonia and hyper-functional dysphonia. This listing of voice disorders is intended to be illustrative and is not intended to be limiting in any way.

Additional readouts of the software may include quantitative measures such as degree of asymmetry, degree of in-homogeneity, or degree of asynchrony in the vibrations of the vocal folds. These terms are deviations from symmetry, homogeneity and synchrony respectively.

In one embodiment, the left-right (L-R) and anterior-medial-posterior (A-M-P) asymmetry/asynchrony of the vocal fold vibrations may be quantitatively measured by the cross correlation coefficient of the displacements of the L-R folds along A-M-P locations, with a value of 1 corresponding to a perfect correlation (in-phase) and −1 for complete out-of-phase.

In one variation, coherence estimate at the fundamental frequency F0, or pitch frequency, may be used to define the correlation of the vocal fold vibrations at two specific L-R or A-M-P locations. The coherence function estimates how two signals are correlated at specific frequencies of interest. In other words, coherence function adds frequency specific information to the correlation coefficient.

In another embodiment a measure of degree of regularity, or a deviation from it, irregularity, maybe generated using analytic signal of the GAW, namely, zGAW. In particular, Hilbert transform is applied to a GAW to generate a complex analytic signal, zGAW, the analytic amplitude, or envelop of the analytic signal is then used to describe the degree of regularity, or a deviation from it, irregularity, of the vocal fold vibration.

In one variation, an index for measure of the degree of irregularity can be defined as follows:

$$DAS = \frac{{[ \frac{1}{N} {\sum }_{k = 1}^{N} {( {E}_{k} - E )}^{2} ]}^{1 / 2}}{\overline{E}}$$

Where, E is the magnitude of the zGAW; Eₖ is the value for the k-th vibratory cycle, Ē is an overall mean value, N is the number of the vibratory cycles.

In another embodiment, the software may generate at least one of the jitter and shimmer indices using one or both of GAW and acoustic signal as a quantitative measure of voice condition.

In another embodiment, the measure of voice condition can be changes in the value of the jitter, shimmer and DAS derived from the GAW or some other change in the characteristic of the Nyquist pattern that includes but is not limited to a harmonic distortion of the glottal waveform shape reflected as a deviation of the Nyquist pattern from a near circle. An index can be defined using a harmonic ratio, which is a ratio of magnitude of a higher-order frequency component, e.g., second-order, to that of the fundamental frequency F0, or pitch of a voice. The harmonic distortion index can be obtained from GAW derived from an image recording or an acoustic recording of a test voice and used as an indicator of degree of nonlinearity of vocal system of the test voice.

In another embodiment, the measure of voice condition can be indicative of a sudden change in the vibratory pattern of the vocal folds, referred to as bifurcation, which can be derived from the phase derived from one or both of the analytic signals constructed from the GAW and the acoustic signal.

In another embodiment, the measure of voice condition can be changes in the timing characteristics of the opening, closing and closed phases of the glottal cycles. The software may generate at least one of the open quotient (OQ) and speed quotient (SQ) of a glottal waveform and other variations that are derived from the glottal waveform.

In one variation, in addition to an overall GAW-derived SQ values, the software may automatically generate three OQ and SQ values based on GAWs obtained from an one-third anterior portion, one-third medial portion and one-third posterior portion of the vocal folds respectively. These values provide a more robust and accurate account of the glottal closure characteristics which may vary to a large extent spatially; this is especially true for pathological larynx with e.g., a localized lesion on a specific anterior-posterior location of the vocal folds.

In another embodiment, the measure of voice condition can be changes in the regularity, or periodicity of the vocal fold vibration. The software may generate an index that quantify the degree of regularity, or periodicity of the vocal fold vibration, or a deviation from it, irregularity, or aperiodicity, utilizing the analytic amplitude, or envelop function of the GAW; an increased measure of the degree of irregularity is also reflected in a scattered Nyquist pattern, which can be indicative of a decreased ability of a subject to sustain an oscillation of the vocal fold vibration that may arise from a voice pathology or age associated changes in the biomechanical properties of the vocal folds.

In another embodiment, the measure of voice condition can be a change in the value of the glottal closure derived from the GAW that may indicate glottal insufficiency, that is, insufficient closure of the vocal folds that can cause leak of air flow and lead to the perception of a breathy voice,

In another embodiment, the measure of voice condition can be changes in the value of spatial-temporal properties of the vocal fold vibrations along the left and right folds and at specific anterior, medial and posterior locations of the vocal folds.

In another embodiment, the measure of voice condition can be changes in the frequency profile, for example, a rhythmic variation at a specific rate may occur in the inter-cycle frequency profile indicating presence of vocal tremor that may result from laryngeal form of essential tremor and tremors that are associated with neurological diseases, for example, Parkinson's disease according to e.g., specific rate of the rhythmic variation.

In one variation, the software comprises utilizing phase function derived from die complex analytic signal, zGAW, to detect any tremor-caused rhythmic frequency variation; and utilizing envelope of the zGAW to detect rhythmic amplitude changes. The software may also include spectrogram analysis for comparisons.

The integrated software may generate a comprehensive and clinician-friendly analysis of the vocal fold vibration. A patient database management module may also be integrated with a comparative database to highlight correlations between characteristics of vocal-fold vibrations and different laryngeal health conditions, as they correlate with the perceived voice quality and acoustic measures.

The methodology described presents a robust assessment of different voice pathologies by providing, in part, more robust and accurate diagnosis by using an integrative analysis approach that, in one variation, combines and con-elates information derived from direct imaging of the vocal fold and indirect acoustic measurement of the vocal output.

Our approach and applications are demonstrated through analyses of several clinical voice recordings representing normal and specific pathological conditions. Examples of the analysis and results are shown in the following section All data samples used for analyses were recorded from subjects during sustained phonation of vowel /i/ on a commercial HSV system (KayPentax; capture rate: 2000 frames per second). The analyses of both the image-derived GAW and the acoustic signal are presented in terms of the Nyquist plots.

“Section titles are terse and are for convenience only.”

### EXAMPLE 1

### Vocal Fold Vibrations and Nyquist Patterns for Normal Voices

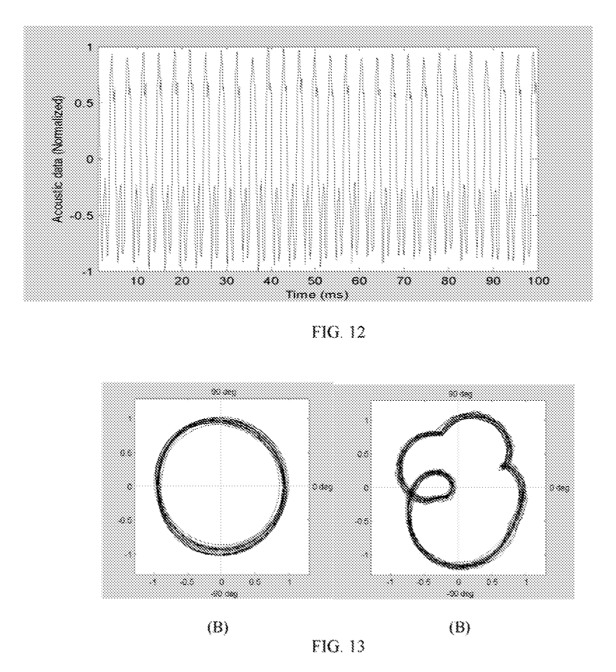

Using the segmentation methods presented in the present invention the GAW can be extracted from a sequence of 200 laryngeal images obtained from HSV recordings of a normal voice (FIG. 11). For comparison, the simultaneously acquired acoustic signal is shown in FIG. 12. Both the image-derived GAW and the acoustic data show quasi-periodicity for this normal voice, which indicates a nearly periodic oscillation of the vocal folds and a sustained voice output The Nyquist Plots obtained from both the GAW and the acoustic analyses are shown in FIG. 13 (A and B); both plots indicate the presence of only a slight cycle-to-cycle scatter and quasi-periodicity of the vocal fold vibration, consistent with the normal voice condition. For these analyses, the GAW (sampling frequency of 2 kHz) and acoustic data (sampling frequency of 50 kHz) were re-sampled and the anti-aliasing filtering (low-pass at 5 kHz) or interpolation was performed prior to the analyses to deliver a better comparison.

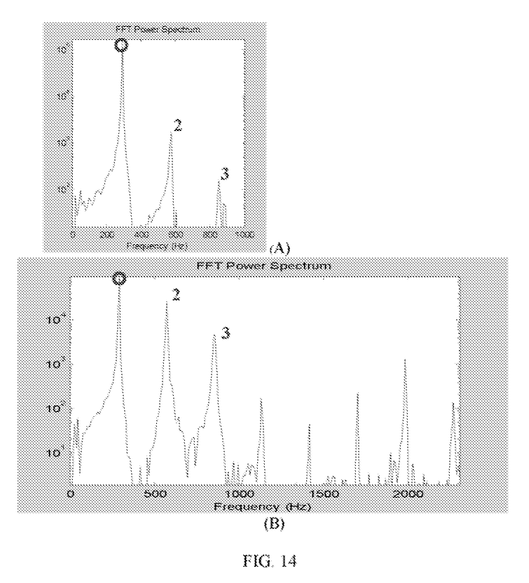

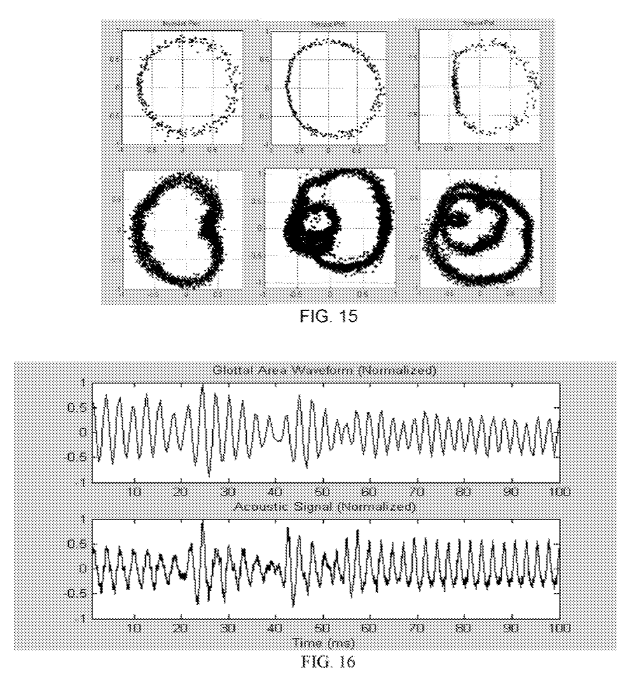

The complexity of the acoustic waveform reflects contributions from both effects of the glottal source dynamics and the vocal tract resonance. The occurrence of the primary peaks in the acoustic data (FIG. 12) correlates with the peak glottal opening, as seen in GAW (FIG. 11). The secondary peaks that lie between the primary peaks in the acoustic data (FIG. 12) clearly result from the vocal tract resonance effect amplifying the second and higher harmonic components, which can also be seen in the acoustic FFT spectrum (FIG. 14B), as compared to the GAW spectrum (FIG. 14A). These acoustic characteristics are revealed, accordingly, in the Nyquist Plots (FIG. 13B) as a more structured pattern; as compared with the GAW Nyquist pattern (FIG, 13A). In summary, the GAW and acoustic data based ‘Nyquist’ patterns both reveal quasi-periodic oscillatory behavior of the vocal folds, which is confirmed by their line frequency spectral characteristics (FIG. 14)—the prominent frequency component occurs at approximately 280 Hz (the fundamental frequency). The acoustic Nyquist pattern shows bimodal, temporal waveform characteristics (FIG. 12) as evidenced by the small cross-over of the analytic phase trace (FIG. 13B). This trace cross-over in the acoustic Nyquist Plot results from the interaction of the glottal source spectrum with the vocal tract transfer function. As expected, the acoustic Nyquist pattern reveals greater complexity in the wave shape, which is associated with the higher degree of nonlinearity effect of the combined glottal source and vocal tract system, as compared to the GAW Nyquist pattern that is related primarily to the vocal fold vibrations.

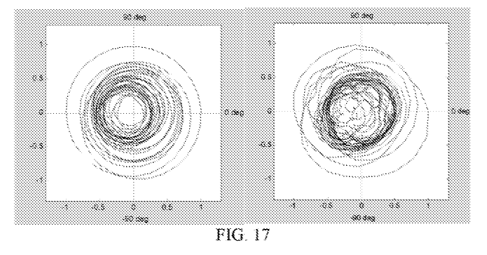

Results from similar analyses detailed in the present invention and obtained three other normal voices are also presented in terms of the Nyquist Plots in FIG. 15. In summary, the GAW analyses show that the normal voice production can be represented by a Nyquist pattern with single, near circular trace with little scatter, indicating the ability of normal subjects to sustain a periodic vocal fold oscillation during a sustained phonation. Consistently, the acoustic Nyquist Plots, reveal slight cycle-to-cycle scatter, although, as expected, the Nyquist patterns are more structured because of the vocal tract resonance effect. The acoustic Nyquist patterns are clearly distinct and specific to each individual (FIG. 15, bottom row) and may serve as ‘vocal prints’ and used for voice-based biometric analyses.

### EXAMPLES 2 AND 3

### Vocal Fold Vibrations and Nyquist Patterns for Pathological Voices

Example 2: Analyses of the voice recorded from a patient with recurrent respiratory papillomatosis (RRP) exhibiting vocal fold stiffness are shown in FIGS. 16 and 17. FIG. 16 show the image derived GAW (upper) and the acoustic signal (lower) respectively. Both waveforms show intermittency indicating the irregular vibratory behavior of the vocal folds and unsteady voice output. This characteristic is comprehensively revealed as significant cycle-to-cycle scatter in the GAW or acoustic Nyquist patterns (FIG. 17).

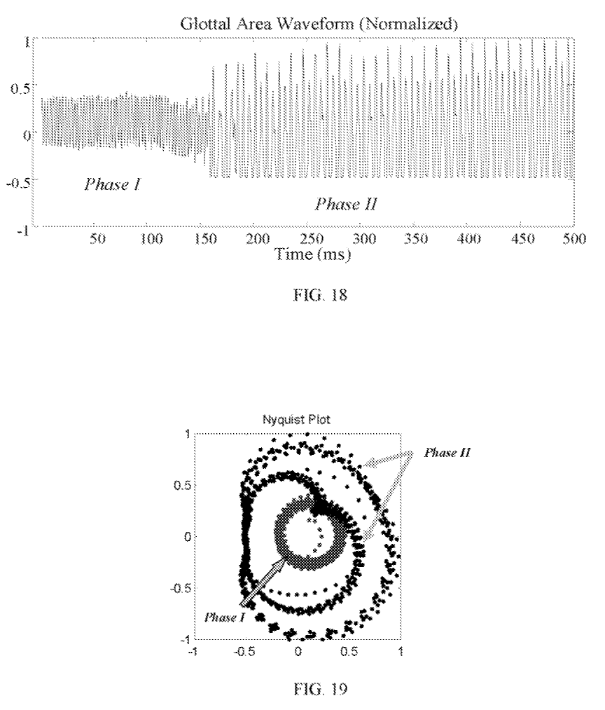

Example 3: Analyses of the voice recorded from a patient with muscular tension dysphonia (MTD), also referred to as functional dysphonia, are shown in FIGS. 18-20. The GAW extracted from a sequence of 1000 image frames (500 milliseconds of recording time) is shown in FIG. 18 and reveals sudden appearance of a qualitatively different vibratory behavior of the vocal folds, or so-called bifurcation. In particular, the vocal fold vibratory pattern changes from a normal, single oscillatory mode with quasi-periodicity (Phase I), to a bi-cyclic oscillatory mode (Phase II) that contains both quasi-periodic primary peaks, and secondary peaks that are synchronized with the primary peaks but temporally phase shifted. In the clinic this is referred to as diplophonia, or simultaneous production of two tones. The change in the vibratory pattern is comprehensively described by the transition of the Nyquist patterns over the two phases (FIG. 19) from a single, near circular trace in Phase I to a double ring-like trace in dipiophonic phase (Phase II).

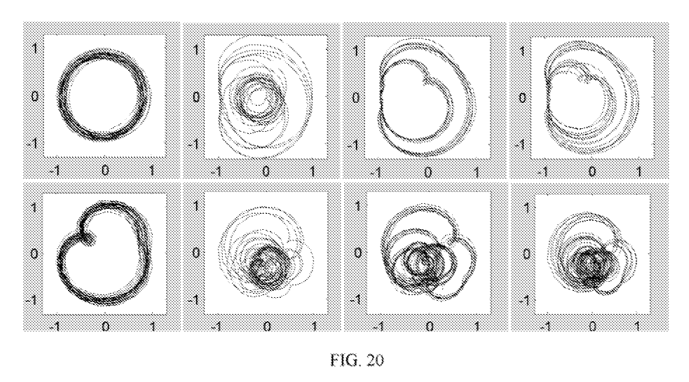

Finally, analyses on three consecutive data sets from the MTD voice (each data set contains 100 ms recordings of images and acoustic data) are presented in FIG. 20 in terms of the Nyquist Plots. The GAW and acoustic Nyquist patterns from these analyses consistently reveal the transition between the normal phase (Phase I) to the dipiophonic phase (Phase II) as well as an increased complexity in the acoustic Nyquist pattern during diplophonia. Evidently, the acoustic Nyquist plots (FIG. 20 lower row) show a more structured pattern with increased number of cross-over during the dipiophonic phase (phase II) (from 1 for phase I to 6 for phase II), indicating an increasingly complex oscillatory behavior of the vocal fold vibration. The number of cross-over, that is the number of cycle, is readily measured from the phase angle, with 1 corresponding to a phase angle of 360 degrees, which is obtained from the complex analytic signal constructed from applying Hilbert transform to the acoustic signal. The number of cross-over can be used as a quantitative indicator of bifurcation and vocal abnormalities.

Examples shown above suggest the method and system described in the present invention improves the application of acoustic, or acoustic and imaging modalities for clinical diagnosis and assessment of voice disorders. The software also improves routine assessment of voice condition using analysis of acoustic or/and image recordings.

Additionally or alternatively, an integrated software (stand alone and/or PDA compatible) and hardware approach may yield quantitative information on vocal dynamics based on novel robust, automated or semi-automated and high fidelity analysis of acoustic or /and image recordings. Several new metrics are demonstrated to describe the characteristics of the vocal fold vibrations that correlate with specific voice disorders, including but not limited to vocal fold paralysis/paresis, Parkinson's disease, vocal fold scarring, laryngeal cancer, spasmodic dysphonia and hyper-functional dysphonia.

These methods and systems may also be suitable for and compatible with personal (acoustic signal analysis; home-use) and healthcare markets (acoustic and image analysis).

For instance, the software can be integrated within a digital voice recorder which can be used to generate visual displays and quantitative metrics of voice condition. The integrated device can be used for personal health monitoring and for tracking treatment results for patients at home or in clinical settings.

The software may also be configured to prompt the user by generating any one of a variety of sounds, such as sustaining a vowel sound for, e.g., about 1 second. Next, the acoustic recording may be analyzed within the device and a comprehensive visual display together with associated quantitative metrics representing the individual's voice and health condition are stored, displayed and managed within the same device. This information may be downloaded to a personal computer.

The analytic phase trace plot, or ‘Nyquist’-plot based approach, may be used to deliver both qualitative and quantitative analysis of the voice that can be used by the individual to monitor his or her voice quality and condition. Daily or periodic analysis of voice condition using quantitative measures of the acoustic signal can be used to indicate to the individual a change in voice condition that may warrant further investigation by a healthcare professional.

Another aspect of the present invention can include a system for performing the methods disclosed in the present invention as well as a machine or device readable storage that allows a machine or device to perform the methods disclosed herein.

The integrated software and hardware may also generate comprehensive and

clinician-friendly analysis and read-out of the vocal output that can be recalled in various formats to reveal how they may have changed over time. These analyses and readouts may indicate at least a voice quality overall health condition, e.g., pressed-ness, or strained-ness in voice, which may be especially useful for professional singers for monitoring their voice trainings. An excessive pressed-ness also may indicate voice pathology, e.g. spasmodic dysphonia, which is characterized by a strained and struggled voice quality-. In addition, the software analsyis system may generate a measure of roughness, which relates to the measure of regularity of the vocal fold vibration, and hoarseness, which is a combination of breathiness that relates to glottal closure measure and roughness.

The visual displays and quantitative metrics associated with long-term monitoring and analysis of an individual's acoustic recordings may correlate with other health conditions beyond the vocal tract and are not limited to complications of the aging process, Parkinson's disease and cancer. The device and the “analyze your voice” concept can be used by people who use their voice for their profession, e.g. actors, singers, broadcasters, educators.

The software for acoustic analysis of voice condition can be implemented over cell phones and will be useful for remote analysis of voice condition by physicians and other healthcare professionals using telemedicine.

Some of the overall advantages, which is not intended to be limiting but merely illustrative, are describe below:
Provides a comprehensive, clinician-friendly description of the vocal fold vibratory behavior that correlates with specific laryngeal health conditions and perceived voice quality;
Provides quantitative measures of the vibratory characteristics of the vocal fold that can be used to establish clinical protocols for the diagnosis of voice disorders for HSV and acoustic techniques;
Provide an integrative analytical system for HSV/LSV and acoustic techniques that includes patient image/acoustic data management, novel image/acoustic analysis modules, as well as quantitative readouts and patient reports;
Improves quality of, and access to, research data for understanding the mechanism of phonation in health and in diseases;
Improves early detection and tracking of staging of voice pathologies as well as evaluation of outcomes of the therapeutic/surgical treatment;
Provides practical and affordable clinical or in-home daily-use portable device for voice/health monitoring through comprehensive analysis of the voice output;
Provides new methods and devices for generating individual ‘vocal print’ or ‘vocal signature’ for biometric analysis.

The applications of the systems and methods discussed above are not limited to the diagnosis and/or treatment of the vocal tissue but may include any number of further treatment applications. Other treatment sites may include areas or regions of the body such as soft, tissue bodies. Modification of the above-described systems and methods and variations of aspects of the invention that are obvious to those of skill in the art are intended to be within the scope of this disclosure.

What is claimed is:

1. A method of obtaining a quantitative measure of voice comprising: utilizing a recording selected from recording types comprising a laryngeal image recording and an acoustic recording of a subject's voice during sustained phonation of at least one vowel; and performing a voice analysis on at least one utterance of said recording of the subject.

2. The method of claim 1, further comprising: utilizing a combination of gray-level threshold segmentation and region growing for automatic or interactive segmentation of glottis and delineation of vocal fold edge and generation of at least one glottal waveform from the laryngeal image recording.

3. The method of claim 2, further comprising: performing an unsupervised histogram-based threshold segmentation, wherein the histogram can be modeled as but not limited to a Rayleigh distribution; subsequently performing an erosion operation to improve reliability of the segmentation; and performing a region-growing operation, wherein a segmented area resulted from the histogram-based threshold segmenting step and the erosion operation performing step is used as an initial ‘seed region’.

4. The method of claim 1, further comprising an automatic, adaptive segmentation that combines grey-level thresholding and a motion cue determined from sequences of difference image derived from original sequences of images obtained from the laryngeal image recording.

5. The method of claim 1, further comprising analyzing a waveform selected from waveform types comprising a) a glottal waveform, and b) the acoustic recording to generate at least one quantitative measure of vibration of the vocal fold and a visual display of a vibratory pattern in a. physician-friendly and comprehensive form that allows at-a-glance view of at least one characteristic measure of vibration of the vocal fold for detection of a voice disorder.

6. The method of claim 5, further comprising generating an inter-cycle frequency and an inter-cycle amplitude distribution using a complex analytic signal obtained from applying a Hilbert transform to a glottal waveform and a subsequent low-pass filtering to obtained envelope and instantaneous frequency.

7. The method of claim 5, further comprising utilizing a complex analytic signal derived Nyquist plot obtained from a low-pass filtered acoustic recording, to generate an at-a-glance view of vocal dynamics and to indicate a voice condition.

8. The method of claim 5, further comprising utilizing a complex analytic signal and phase information derived from a glottal waveform to detect tremor in voice that includes but not limited to a laryngeal form of essential tremor and tremor in a Parkinson's voice.

9. The method of claim 5, further comprising generating a robust measure of mean values of open quotient (OQ) and speed quotient (SQ) and other forms of variations using a glottal area waveform and first derivative of the glottal area waveform extracted from a laryngeal image recording over a plurality of glottal cycles.

10. The method of claim 5, further comprising: introducing an index to quantify regularity, or periodicity, or a deviation from if, irregularity or aperiodicity, of the vocal fold vibration using a complex analytic signal and envelop function obtained from a glottal waveform; and introducing a measure of harmonic distortion using a glottal waveform for detection of a voice condition.

11. A method comprising utilizing a Nyquist pattern derived from an acoustic recording of a subject's voice during sustained phonation of at least one vowel to generate an individual ‘vocal print’ or ‘vocal signature’ for indication of a voice quality and an application in but not limited to biometric analysis.

12. A system for assessing and diagnosing a voice condition comprising a voice analyzer that takes, in a variety format, a recording selected from recording types comprising a laryngeal image recording and an acoustic recording of a subject's voice during sustained phonation of at least one vowel.

13. The system of claim 12, further comprising: an archiving and managing module for said laryngeal image recording and acoustic recording; and a patient report module for reporting an analysis and diagnosis.

14. The system of claim 12, further comprising a database of both normative and aging and specific pathology related voice characteristics and Nyquist pattern.

15. The system of claim 12, further comprising a multi-panel display of a processed laryngeal image sequence with montage and a frame-by-frame viewing option and real-time display of said glottal waveform.

16. The system of claim 12, further comprising: a means for comparing at least one property of the vocal fold vibration with that obtained from normal voice recording or from recordings of patients with defined voice disorders; and a means for determining at least one measure of the said voice that correlates with the specific voice condition or disease.

17. The system of claim 12 comprising: a means of interactive or automatic tracing of vocal-fold motion from a laryngeal image recording using a combination of gray-level threshold segmentation and region growing; and a generator of at least one glottal waveform from the laryngeal image recording and one quantitative measure of voice condition,

18. The system of claim 12, further comprising: a means for interactively segmenting a laryngeal image recording on a frame-by-frame basis using one or a combination of gray-level and color attributes; and a ‘slider’ formatting tool with a real-time display of segmentation results and feedback that is used for interactive adjusting of a threshold value for both the gray-level segmentation and the region-growing.

19. The system of claim 12, further comprising an interactive selector of a region of interest (ROI), wherein the ROI is not limited to a regular rectangle and could be varied for a different image frame of a laryngeal image recording.

20. The system of claim 12, further comprising a means for generating a complex analytic signal from an acoustic signal to generate a phase trace plot, or ‘Nyquist plot’, and means for comparing with that obtained from a glottal waveform obtained from a laryngeal image recording.

21. The system of claim 12, further comprising a means for generating at least an index for measurement of regularity, or periodicity, or a deviation from it, irregularity or aperiodicity, of vocal fold vibration for detection of a voice condition.

22. The system of claim 12, wherein attributes of a specific voice condition of a laryngeal image recording include a measure of harmonic distortion derived from a glottal waveform for indication of a voice quality.

23. The system of claim 1.2, further comprising: a generator of a spatially resolved map of vocal fold motions along the left and right and anterior, medial and posterior of the vocal folds using a display type selected from 2D and 3D displays; and a readout of at least a measure of symmetry, or a deviation from it, asymmetry, in bilateral vibrations of left-right vocal folds at a specific anterior-medial-posterior location; and a readout of a measure of asynchrony in vibrations of the vocal fold at two specific anterior-medial-posterior locations.

24. The system of claim 12, wherein a voice condition attributes of a laryngeal image recording include a measure of glottal insufficiency, derived from a normalized glottal waveform, in particular, a cycle-to-cycle minimum value of the normalized glottal waveform, which may vary from one vibratory cycle to another.

25. The system of claim 12, wherein a voice condition attributes of a test voice including a measure of bifurcation of the vocal fold vibration derived from a glottal waveform, and a measure of degree of nonlinearity of a vocal system derived from an acoustic recording.

26. The system of claim 23, wherein a voice condition attributes of a test voice including the spatially resolved asymmetry and asynchrony measures of vibrations between left and right vocal folds and at specific anterior-medial-posterior locations of the vocal fold.

27. The system of claim 12, further comprising a version that is compatible with operation within a selected fixed and portable device including but not limited to a digital voice recording device, a cell phone and a PDA (Personal Digital Assistant) device.

28. The system of claim 12 further comprising: an analyzer talking said acoustic recording to provide an indicator of at least one voice quality, and a measure of pressed-ness or strained-ness in the subject's voice.

29. A machine readable storage, having a stored computer program with a plurality of code modules executable by a machine or stand alone computer to perform the steps comprising; managing and processing a voice recording derived from an image or acoustic device; tracing the vocal fold edges using at least one edge detection modality; extracting a glottal waveform and analyzing said glottal waveform using an approach not limited to the a Nyquist plot for determining at least one voice condition attribute front the voice recording; comparing the at least one voice condition attribute from the voice recording with at least one voice condition attribute derived from a recording of a patient with known voice condition or disease; and based upon said comparing step, determining at least one measure of voice condition of the voice recording; generating a report of the analysis in a physician friendly form that is not limited to records of the patient, the time and date of the recording, a summary of the analyses; an indication based on comparison with a database on the condition of the voice or association with a specific voice disorder or disease.

30. A hardware and stand-alone portable device, namely a voice pod (V-pod) or health pod (H-pod), for in-home and clinical monitoring of voice, comprising: a voice analyzer taking an acoustic recording of a subject's voice during sustained phonation of at least one vowel; generating at least a measure of jitter, shimmer, harmonic distortion, degree of regularity and degree of nonlinearity.

31. The portable device of claim 30, further comprising a generator, a displayer and a storage of a Nyquist pattern derived from said acoustic signal of a test voice to represent an individual ‘vocal print’ or ‘vocal signature’.

32. The portable device of claim 30, further comprising: an analyzer taking said acoustic recording to indicate at least one voice quality, and to provide at least a measure of pressed-ness or strained-ness in the subject's voice.

33. A system comprising an analyzer taking an acoustic recording of a subject's voice during sustained phonation of at least one vowel and generating a Nyquist pattern to represent a ‘vocal print’ or ‘vocal signature’ for detection of a voice condition and an application in but not limited to biometric analysis.
